(19) United States
(12) Patent Application Publication
(10) Pub. No.: US 2026/0359036 A1
(43) Pub. Date: Nov. 12, 2026

(54) METHOD OF UPDATING AI MODEL IN CLOUD ENVIRONMENT, AND ELECTRONIC DEVICE AND SYSTEM FOR PERFORMING THE SAME

(71) Applicant: SAMSUNG ELECTRONICS CO., LTD., Suwon-si (KR)

(72) Inventors: Kyungsun CHO, Suwon-si (KR); Jaemin RYU, Suwon-si (KR)

(73) Assignee: SAMSUNG ELECTRONICS CO., LTD., Suwon-si (KR)

(21) Appl. No.: 19/689,211

(22) Filed: May 27, 2026

Related U.S. Application Data
(63) Continuation of application No. PCT/KR2026/096855, filed on May 12, 2026.

(30) Foreign Application Priority Data
May 12, 2025 (KR) 10-2025-0061456

(51) Int. Cl. G06F 8/65; H04L 9/08; H04L 9/32

(52) U.S. Cl. CPC G06F 8/65; H04L 9/0861; H04L 9/3247; H04L 9/3278

(57) ABSTRACT

A method may include obtaining, by a user terminal, a base artificial intelligence (AI) model. The base AI model may be obtained from a server. The method may include obtaining, by the user terminal, a personalized AI model by performing fine-tuning on the base AI model based on user data. The user data may be collected in a process of executing the base AI model on the user terminal. The method may include generating, by the user terminal, model-specific information corresponding to the personalized AI model based on unique properties of the user terminal. The method may include performing, by the user terminal, signing on the personalized AI model by using the model-specific information. The method may include transmitting, by the user terminal to the server, the model-specific information and the signed personalized AI model.

### CROSS-REFERENCE TO RELATED APPLICATIONS

This application is a continuation of International Application No. PCT/KR2026/096855, filed on May 12, 2026, which is based on and claims priority to Korean Provisional Patent Application No. 10-2025-0061456, filed on May 12, 2025, in the Korean Intellectual Property Office, the disclosures of which are incorporated by reference herein in their entireties.

### BACKGROUND

### 1. Field

The disclosure relates to a method of updating an artificial intelligence (AI) model in a cloud environment, and more particularly, to a method of selecting a personalized AI model to be incorporated in an update of a base AI model by a server when a user terminal transmits, to the server, a personalized AI model generated in an on-device environment.

### 2. Description of Related Art

With recent advancements in artificial intelligence (AI) technology, various AI models, including large language models (LLMs), have been provided in cloud environments. These AI models are typically generated through pre-training and then optimized by incorporating user input and performing fine-tuning thereon.

For example, a personalized AI model in which the user’s preferences and style are incorporated may be generated by fine-tuning a base AI model provided by a server based on the user input while executed in an on-device environment. The fine-tuned personalized AI model may be used to update the base AI model in the server.

However, some personalized AI models may be trained with biased data or distorted information, and thus may be unsuitable for updating the base AI model in the server. When these unsuitable models are used for updates, the bias of the base AI model may increase or the performance thereof may deteriorate. Therefore, when the base AI model is updated using a plurality of personalized AI models, a technology is need to exclude unsuitable models when updating a base AI model.

The background technology described above is technical information that the inventor possessed for deriving the disclosure or acquired in the process of deriving the disclosure and therefore cannot necessarily be considered as prior art publicly disclosed before the filing of the disclosure.

### SUMMARY

According to one or more embodiment of the present disclosure, a method may include obtaining, by a user terminal, a base artificial intelligence (AI) model. The base AI model may be obtained from a server. The method may include obtaining, by the user terminal, a personalized AI model by performing fine-tuning on the base AI model based on user data. The user data may be collected in a process of executing the base AI model on the user terminal. The method may include generating, by the user terminal, model-specific information corresponding to the personalized AI model based on unique properties of the user terminal. The method may include performing, by the user terminal, signing on the personalized AI model by using the model-specific information. The method may include transmitting, by the user terminal to the server, the model-specific information and the signed personalized AI model.

According to one or more embodiment of the present disclosure, a user terminal may include: memory storing instructions; and at least one processor operatively coupled to the memory and including processing circuitry. The at least one processor individually or collectively executes the instructions to cause the user terminal to: obtain a base AI model from a server, obtain a personalized AI model by performing fine-tuning on the base AI model based on user data. The user data may be collected in a process of executing the base AI model. The at least one processor individually or collectively executes the instructions to cause the user terminal to: generate model-specific information corresponding to the personalized AI model based on unique properties of the user terminal, perform signing on the personalized AI model by using the model-specific information, and transmit, to the server, the model-specific information and the signed personalized AI model.

According to one or more embodiment of the disclosure, a system for updating an AI model in a cloud environment may include a server configured to provide a base AI model, update the base AI model, and a user terminal configured to provide a user interface (UI) for using the base AI model, and in this case, the user terminal may obtain the base AI model from the server, obtain a personalized AI model by performing fine-tuning on the base AI model based on user data collected in a process of executing the base AI model, generate model-specific information corresponding to the personalized AI model based on unique properties of the user terminal, perform signing on the personalized AI model by using the model-specific information, and then transmit the model-specific information and the signed personalized AI model to the server.

According to one or more embodiment of the disclosure, a computer-readable recording medium may have stored thereon a program for executing, on a computer, at least one of the embodiments of the disclosed method.

According to one or more embodiment of the disclosure, a computer program may be stored on a medium for performing, on a computer, at least one of the embodiments of the disclosed method.

### DESCRIPTION OF THE DRAWINGS

FIG. 1 illustrates a system that provides an artificial intelligence (AI) service in a cloud environment according to an embodiment of the disclosure;

FIG. 2 illustrates a security execution framework included in a user terminal according to an embodiment of the disclosure;

FIG. 3 illustrates operations performed by a user terminal and a server in sequence;

FIG. 4 illustrates a process in which a user terminal generates model-specific information, performs signing on a personalized AI model by using the generated model-specific information, and then transmits the generated information to a server, according to an embodiment of the disclosure;

FIG. 5 illustrates detailed information included in model-specific information according to an embodiment of the disclosure;

FIG. 6 is a diagram illustrating a method of determining whether a personalized AI model is an unsuitable model by comparing parameters of the personalized AI model and the base AI model;

FIG. 7 is a diagram for explaining a method of determining whether a personalized AI model is an unsuitable model by comparing parameters between a model after additional training of a base AI model by using the personalized AI model and the base AI model;

FIGS. 8 and 9 are diagrams illustrating a process in which a server determines whether to use a personalized AI model to update a base AI model based on model-specific information, according to an embodiment of the disclosure;

FIG. 10 is a diagram illustrating components included in a user terminal according to an embodiment of the disclosure; and

FIGS. 11-14 are flowcharts illustrating a method of updating an AI model in a cloud environment according to embodiments of the disclosure.

### DETAILED DESCRIPTION

The embodiments described herein are non-limiting example embodiments, and thus, the disclosure is not limited thereto and may be realized in various other forms.

With regard to the description of the disclosure, technical features that are not directly related to the disclosure are not described here. Certain detailed explanations of related art are omitted for clarity when it is deemed that they may unnecessarily obscure the essence of the disclosure. The terms used in the specification are defined in consideration of functions used in the disclosure, and may be changed according to the intent or conventionally used methods of clients, operators, and users. Accordingly, definitions of the terms should be understood on the basis of the entire description of the present specification.

In the same reason, some components in the following drawings may be exaggerated, omitted, or schematically illustrated. The sizes of components do not reflect their actual sizes completely. The same reference number is given to the same or corresponding components in each drawing.

Advantages and features of the disclosure, and methods of achieving them may be clear with reference to the detailed description of the following embodiments taken in conjunction with the accompanying drawings. However, the disclosure is not limited to the embodiments disclosed below, but may be implemented in various different forms. These embodiments are intended to complete the disclosure, and are common in the art to which the disclosure belongs, and it is provided to fully inform the person skilled in the art of the scope of the disclosure. an embodiment of the disclosure is defined by the scope of the claims. Like reference numerals refer to like elements throughout the specification. In the following description of an embodiment of the disclosure, a detailed description of functions and configurations incorporated herein will be omitted when it may make the subject matter of the disclosure unclear. The terms used in the specification are defined in consideration of functions used in the disclosure, and may be changed according to the intent or conventionally used methods of clients, operators, and users. Accordingly, definitions of the terms should be understood on the basis of the entire description of the present specification.

According to an embodiment of the disclosure, combinations of each block of flowcharts and the flowcharts may be performed by computer program instructions. Computer program instructions may be installed on a processor of a general computer, a special computer or other programable data processing equipment, and the instructions executed through the processor of the computer or other programable data processing equipment may generate an element for performing functions described in block(s) of flowcharts. Computer program instructions may be stored in computer available or computer readable memory that may aim for a computer or other data processing equipment to implement functions in a certain way, and instructions stored in the computer available or computer readable memory may also produce manufacturing items that contain instruction elements for performing the functions described in the block(s) of the flowcharts. It is also possible that computer program instructions are installed on a computer or other programable data processing equipment.

Each block of flowcharts may indicate a part of a module, segment or code including one or more executable instruments for executing a certain logical function(s). According to an embodiment of the disclosure, it is also possible that functions mentioned in the blocks are performed out of order. For example, two blocks that are consecutively shown may actually be performed at the same time, or in reverse order depending on the function.

The term “unit” in an embodiment of the disclosure means a software component or a hardware component, such as a field programmable gate array (FPGA) or an application specific integrated circuit (ASIC), that performs a certain function. However, the term “unit” is not limited to software or hardware. The “unit” may be formed to be stored in an addressable storage medium, or may be formed to operate one or more processors to reproduce the same. In an embodiment of the disclosure, the term “unit” may refer to components such as software components, object-oriented software components, class components, and task components, processes, functions, attributes, procedures, subroutines, segments of program code, drivers, firmware, micro code, circuits, data, databases, data structures, tables, arrays, and parameters. Functions provided by certain elements and a certain “unit” may be combined in a smaller number of elements or may be separated into additional elements. In an embodiment of the disclosure, the “unit” may include one or more processors.

Hereinafter, the meanings of terms used in the disclosure are explained.

A ‘base AI model’ may refer to a pretrained artificial intelligence (AI) model that is provided, for example in a cloud environment, and is utilized in various AI services. According to an embodiment of the disclosure, a base AI model may be transmitted from a server operated by a service provider to a user terminal, stored in the user terminal, and then executed in an on-device environment by the user terminal. The base AI model may include various types of AI models, including a generative model.

In the disclosure, the term ‘base AI model’ may be replaced with terms such as ‘common AI model’, ‘foundation model’, ‘pretrained model’, ‘public AI model’, or ‘original AI model’.

A ‘personalized AI model’ may mean a model obtained by fine-tuning a base AI model with user data. That is, the personalized AI model may be a model that is a customized extension of the base AI model.

According to an embodiment of the disclosure, a personalized AI model may be generated by fine-tuning a base AI model based on user input (e.g., prompt) used in a process of executing the base AI model in an on-device environment of a user terminal. The personalized AI model may provide private customized output by incorporating a user’s preferences, style, and specific response patterns.

In the disclosure, the term ‘personalized AI model’ may be replaced with terms such as ‘private AI model’, ‘fine-tuned AI model’, ‘adapted AI model’, ‘customized AI model’, or ‘user model’.

An ‘unsuitable model’ may refer to a personalized AI model that is not suitable for use in updating the base AI model due to being trained on biased data, having distorted information, or other reasons. According to an embodiment of the disclosure, a server may determine an unsuitable model from among personalized AI models received from a plurality of user terminals, and exclude the personalized AI model determined to be an unsuitable model when updating the base AI model.

In the disclosure, the term ‘unsuitable model’ may be replaced with terms such as ‘poisoned model’, ‘biased model’, ‘inadequate model’, or ‘inappropriate model’.

‘User data’ may refer to data including user input (e.g., prompt), interaction records, and user-related information to be used to fine-tune AI models. That is, the user data may include user input received during a process of executing the base AI model in an on-device environment of the user terminal. For example, when a user uses an AI service through a user terminal, the user inputs a prompt requesting a certain task, and the base AI model may perform inference based on the prompt, and in this case, the input prompt may be included in the user data.

In the disclosure, the ‘user data’ may be replaced with terms such as ‘user input’, ‘input data’, or ‘user information’.

A ‘device key’ is a cryptographic key uniquely assigned to a certain terminal, and may be used for purposes such as terminal authentication, secure communication, and data signing. According to an embodiment of the disclosure, the device key may be generated based on unique properties of the hardware of the user terminal. For example, a physical unclonable function (PUF)-based key (e.g., CPU ID) may be generated based on the physical properties of one or more processors (e.g., CPU chip) included in a user terminal, and a device key may be generated based on the PUF-based key. The PUF-based key may be used as a device key, or the device key may be generated using the PUF-based key. The device key may be used to check a source of the personalized AI model in the server.

‘Model-specific information’ may refer to information that specifies a personalized AI model. According to an embodiment of the disclosure, model-specific information may be generated based on the device key (e.g., CPU ID). For example, other information may be added to the device key to generate model-specific information. In detail, in addition to the device key, the model-specific information may include information about the region and time in which the personalized AI model is generated, information about a terminal that generates the personalized AI model, and information about a software environment in which the personalized AI model is generated (e.g., trusted execution environment identifier TEE ID or instance ID). The user terminal may generate model-specific information when a personalized AI model is generated and transmit, to the server, the model-specific information along with the personalized AI model.

Hereinafter, embodiments of the disclosure will be described in detail with reference to the drawings.

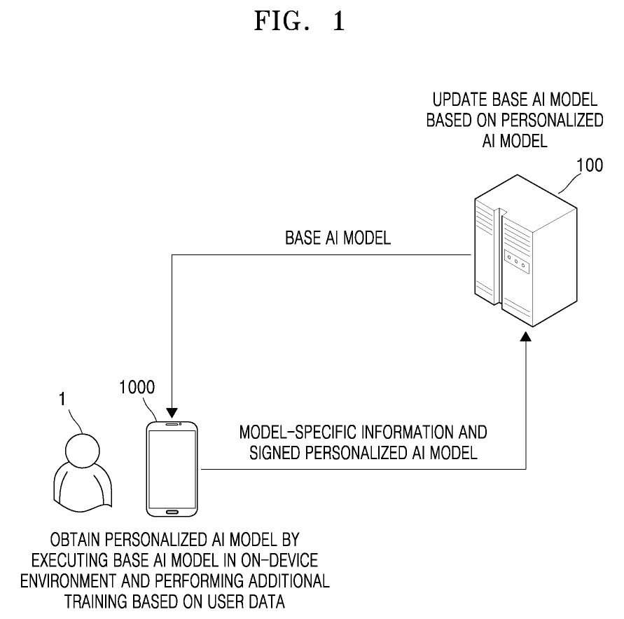

1. Overall system for implementing embodiments of the disclosure (FIG. 1)

FIG. 1 illustrates a system that provides an AI service in a cloud environment according to an embodiment of the disclosure. Referring to FIG. 1, the system may include a server 100 and a user terminal 1000.

A pretrained base AI model may be stored in the server 100 operated by a service provider providing an AI service. The base AI model may be embodied as various types of AI models, including a generative model such as a large language model (LLM).

The user terminal 1000 may download the base AI model from the server 100 and execute the base AI model in an on-device environment. A user 1 may use an AI service through the user terminal 1000.

In a process in which the user 1 uses an AI service, user data may be collected from the user terminal 1000. The user data may refer to data to be used for fine-tuning an AI model, as described above.

For example, when the user 1 inputs a prompt through the user terminal 1000, the base AI model executed on the user terminal 1000 may perform an inference according to the input prompt and output the result through the user terminal 1000. The prompt input during this process may be collected as user data.

The user data may include records of interactions between the user 1 and the user terminal 1000 that occur during a process of the user 1 using the AI service. The user data may include all types of user-related information to be used for fine-tuning the base AI model.

The user terminal 1000 may generate a personalized AI model optimized for the user 1 by performing fine-tuning on the base AI model by using the collected user data. The personalized AI model may provide private customized output by incorporating the preferences, style, and specific response patterns of the user 1.

When the personalized AI model is generated, the user terminal 1000 may generate model-specific information corresponding to the personalized AI model. The model-specific information may be information that specifies the personalized AI model generated in the user terminal 1000. The model-specific information may be used to check a source of the personalized AI model in the server 100 or to obtain other information about the personalized AI model (e.g., information about when and where the model was generated and which group the model was generated by).

According to an embodiment of the disclosure, the model-specific information may be generated based on unique properties of the user terminal 1000. For example, the model-specific information may be generated based on a unique key that is derived from the physical properties of one or more processors included in the user terminal 1000. Therefore, the model-specific information may be used to identify the user terminal 1000 that generates the personalized AI model.

A detailed method of generating the model-specific information and detailed information included in the model-specific information is described in detail below with reference to other drawings.

When the model-specific information is generated, the user terminal 1000 may perform signing on the personalized AI model by using the model-specific information and transmit, to the server 100, the model-specific information and the signed personalized AI model.

The server 100 may update the base AI model by performing additional training on the base AI model stored in the server 100 by using the personalized AI model received from the user terminal 1000. The server 100 may receive a plurality of personalized AI models from a plurality of terminals, exclude some models that are determined to be unsuitable for use in additional training, and update the base AI model by incorporating the remaining models which are suitable for use in additional training.

In one or more embodiments, a method by which the server 100 determines whether a personalized AI model is suitable for use in additional training is as follows.

### 1. Determine whether the personalized AI model is an unsuitable model

The server 100 may determine whether the personalized AI model is an unsuitable model by comparing parameters of models. According to an embodiment of the disclosure, the server 100 may determine whether the personalized AI model is an unsuitable model based on the result of comparing the parameters of any one of the following pairs of models.
i) Compare parameters between the personalized AI model and the base AI model.
ii) Compare the parameters between a model after the base AI model is updated (post-update model) by using the personalized AI model and the base AI model (pre-update model).

When the parameters of the two models differ by a certain reference or more, the server 100 may determine that the personalized AI model is an unsuitable model. The fact that the parameters of the two models differ significantly means that a degree to which the base AI model changes is significant when the personalized AI model is used for additional training. A method by which the server 100 determines whether parameters of two models differ by a certain reference or more is as follows.

First, the server 100 may calculate a difference in parameter values for each pair of corresponding nodes of the two models, obtain an average of the differences calculated for all nodes, and compare the average with a predetermined threshold. When the average is greater than the predetermined threshold, the server 100 may determine that the personalized AI model is an unsuitable model.

Second, the server 100 may calculate the difference in parameter values for each pair of corresponding nodes of the two models, obtain a variance of the differences calculated for all nodes, and compare the variance with a predetermined threshold. When the variance is greater than the predetermined threshold, the server 100 may determine that the personalized AI model is an unsuitable model.

Third, the server 100 may calculate the difference in parameter values for each pair of corresponding nodes of the two models and check the number of node pairs having a difference greater than a predetermined value. When the checked number of node pairs is greater than a predetermined threshold, the server 100 may determine that the personalized AI model is an unsuitable model.

The server 100 may exclude the personalized AI model that is determined to be an unsuitable model from additional training of the base AI model.

### 2. Determine Whether to use the Personalized AI Model for Additional Training Based on Model-specific Information

When the server 100 discovers at least one personalized AI model that is an unsuitable model according to any of the methods described above, the server 100 may determine whether to use the personalized AI model received thereafter for additional training based on model-specific information received together.

In detail, the server 100 may determine a degree of relevance between a newly received personalized AI model and a personalized AI model previously determined to be an unsuitable model based on the model-specific information. The server 100 may determine not to use a personalized AI model for updating the base AI model with a relevance equal to or greater than a certain reference with the personalized AI model previously determined to be the unsuitable model.

According to an embodiment of the disclosure, the server 100 may determine, based on the model-specific information, whether the received personalized AI model is one of the following two types.
i) Personalized AI model transmitted from a terminal that previously transmitted an unsuitable model.
ii) Personalized AI model transmitted from a terminal having a high relevance with a terminal that previously transmitted an unsuitable model.

The server 100 may determine not to use the two types of models for updating the base AI model. Alternatively, the server 100 may not immediately determine not to use the two types of models for updating the base AI model, but may determine whether the corresponding models are unsuitable models. In one or more embodiments, the method of determining whether the corresponding models are unsuitable models is as described above.

For example, the server 100 may determine not to use a personalized AI model with the same source as an unsuitable model for additional training. That is, the server 100 may exclude from additional training of the personalized AI model generated by the same user terminal as the personalized AI model previously determined to be an unsuitable model.

To this end, the server 100 may check the source of the personalized AI model based on the model-specific information. The model-specific information may be generated based on the unique properties of the user terminal 1000, and thus the server 100 may identify the user terminal 1000 that generates or transmits the personalized AI model based on the model-specific information.

Alternatively, for example, the server 100 may calculate a score for a relevance between models (e.g., an unsuitable model and an personalized AI model) based on the location and time in which a model is generated and a group to which the terminal that generates the model belongs. When the calculated score is equal to or greater than a preset reference, the server 100 may determine not to use the personalized AI model for additional training. The model-specific information may include information about the location and time in which the personalized AI model is generated, and a group of a terminal that generates the model.

The server 100 may transmit, to the user terminal 1000, the updated base AI model through additional training. Accordingly, the updated base AI model may be stored again in the user terminal 1000 and executed in on-device form.

### 2. The overall Process in Which the Base AI Model is Executed and Updated

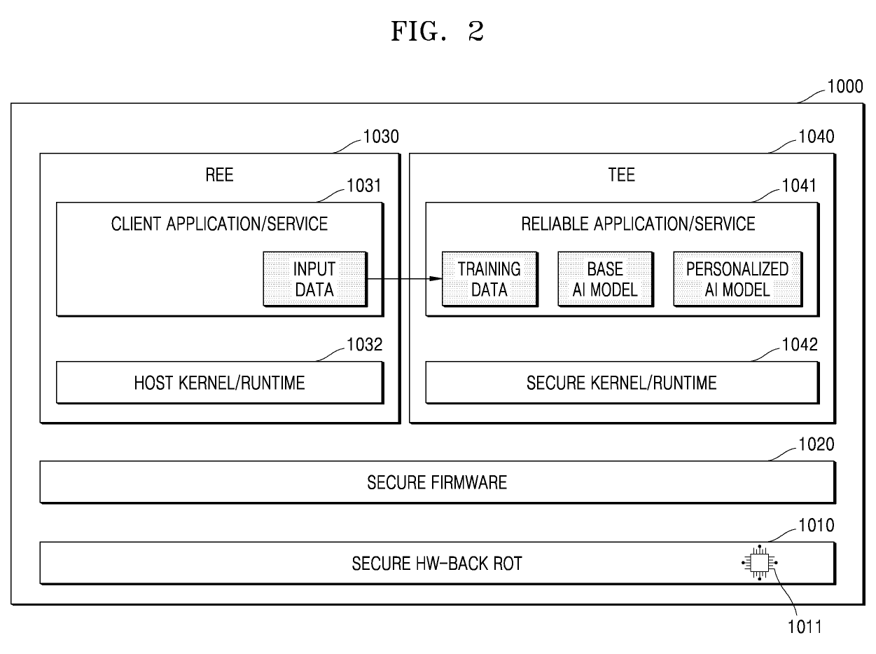

Hereinafter, the overall process of executing and updating the base AI model is described in detail with reference to FIGS. 2-7.

### 1. Security Execution Framework of user Terminal FIG. 2

Before explaining the overall process, the security execution framework of the user terminal 1000 that executes and fine-tunes the base AI model is described. That is, a method according to one or more embodiments of configuring an environment in which the base AI model is executed and fine-tuned is described.

FIG. 2 illustrates a security execution framework included in a user terminal according to an embodiment of the disclosure. Referring to FIG. 2, the user terminal 1000 may include a secure hardware (HW)-back root-of-trust (RoT) 1010, a secure firmware 1020, a regular execution environment (REE) 1030, and a trusted execution environment (TEE) 1040.

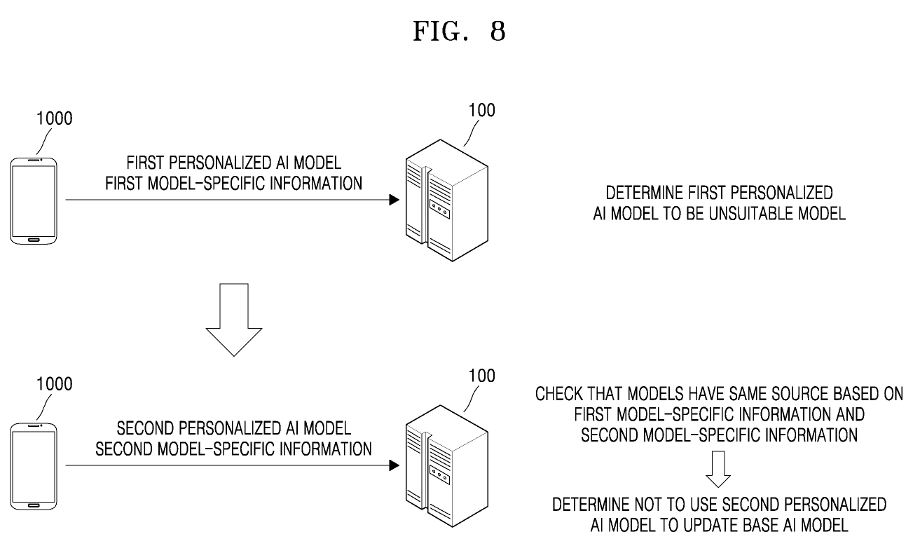

The secure HW-back RoT 1010 may be a security module built into a central processing unit (CPU) chip 1011 and configured to be unchangeable. The secure HW-back RoT 1010 may maintain the security of the user terminal 1000, and in particular, ensure the reliability or verify the integrity of the TEE 1040. That is, the secure HW-back RoT 1010 may ensure that the TEE 1040 is a reliable environment. The CPU chip 1011 may be configured to correspond to or be included in a processor 1300 of the user terminal 1000 illustrated in FIG. 8, which will be described below.

The secure HW-back RoT 1010 may provide hardware-based security for key management and cryptographic calculation. For example, the secure HW-back RoT 1010 may generate a CPU ID based on the unique physical properties of the CPU chip 1011. The CPU ID may be used as a device key or the device key may be generated based on the CPU ID. The secure HW-back RoT 1010 may generate model-specific information based on the device key.

The secure firmware 1020 may establish a reliable environment in association with the secure HW-back RoT 1010 during a booting process of the user terminal 1000 and protect a system of the user terminal 1000 through firmware updates and security patches. The secure firmware 1020 may perform signing by using the model-specific information for the personalized AI model.

The user terminal 1000 may have two separate execution environments, the REE 1030 and the TEE 1040. The two execution environments may differ in a level of security and reliability.

The REE 1030 may be an environment for executing general applications and operating systems and implemented based on software. The REE 1030 may be only protected by software, and thus may have low security and applications may be executed freely. Most programs, such as applications and browsers installed on the user terminal 1000, may be executed in the REE.

In the REE 1030, a client application/service 1031 and a host kernel/runtime 1032 may be executed.

The client application/service 1031 may be a general application for providing a service to the user 1. According to an embodiment of the disclosure, the user 1 may use an AI service through the client application/service 1031. That is, the client application/service 1031 may provide a user interface (UI) for using the AI service to the user 1 and provide the AI service by interacting with the base AI model.

The client application/service 1031 may receive input data (e.g., prompt) for using the AI service from the user 1 through the UI. Input data collected in a process in which the user 1 uses the AI service may be used for fine-tuning the base AI model. However, to protect the privacy of the user 1, the collected input data may not be directly used as training data, but may be used as training data after being partially changed or modified. For example, the user terminal 1000 may anonymize the collected input data or remove or convert sensitive information such that private information of the user 1 is not included. Alternatively, for example, the user terminal 1000 may apply a data transformation scheme (e.g., synonym substitution or sentence structure reconstruction) to generate training data that is differentiated from direct user input while maintaining the meaning of the original data.

The client application/service 1031 may deliver, to the Tee 1040, a request for a function or operation that requires security.

The host kernel/runtime 1032 may be an operating system kernel and provide a runtime environment for executing an application. That is, the host kernel/runtime 1032 may execute general applications and manage system resources.

The TEE 1040 may be an execution environment for performing a security-critical task and may be implemented based on hardware. For example, the TEE 1040 may be implemented by a protected area within a separate processor or the CPU chip 1011 with enhanced security. That is, a code executed in the TEE 1040 may be executed by the protected area within the separate processor or the CPU chip 1011 with enhanced security.

The TEE 1040 may ensure a higher level of security than the REE 1030 and may be protected from external attacks. The TEE 1040 may be completely separated from the REE 1030, and malicious code executed in the REE 1030 may not access the TEE 1040. Therefore, data processed in the TEE 1040 may be hardware-protected, and a security-critical calculation may be executed in the TEE 1040. For example, in the TEE 1040, fine-tuning of the base AI model using training data may be performed. For example, calculations that need security among calculations may be performed by an AI engine may be executed in the TEE 1040.

In the TEE 1040, a reliable application/service 1041 and a secure kernel/runtime 1042 may be executed.

The reliable application/service 1041 may be a security application executed in the TEE 1040 and may perform security-related calculation requested by the REE 1030. For example, when the client application/service 1031 requests the reliable application/service 1041 when secure calculation is required, the reliable application/service 1041 may return, to the REE 1030, only the result after security verification.

According to an embodiment of the disclosure, the reliable application/service 1041 may perform sensitive data processing of an AI model. For example, in the reliable application/service 1041, the AI engine may obtain the personalized AI model by performing fine-tuning on the base AI model by using training data.

The secure kernel/runtime 1042 may manage a reliable application within the TEE 1040 to be safely executed. That is, the secure kernel/runtime 1042 may protect and execute the reliable application/service 1041. The secure kernel/runtime 1042 may ensure secure execution of the AI model and protect the AI model from external attacks.

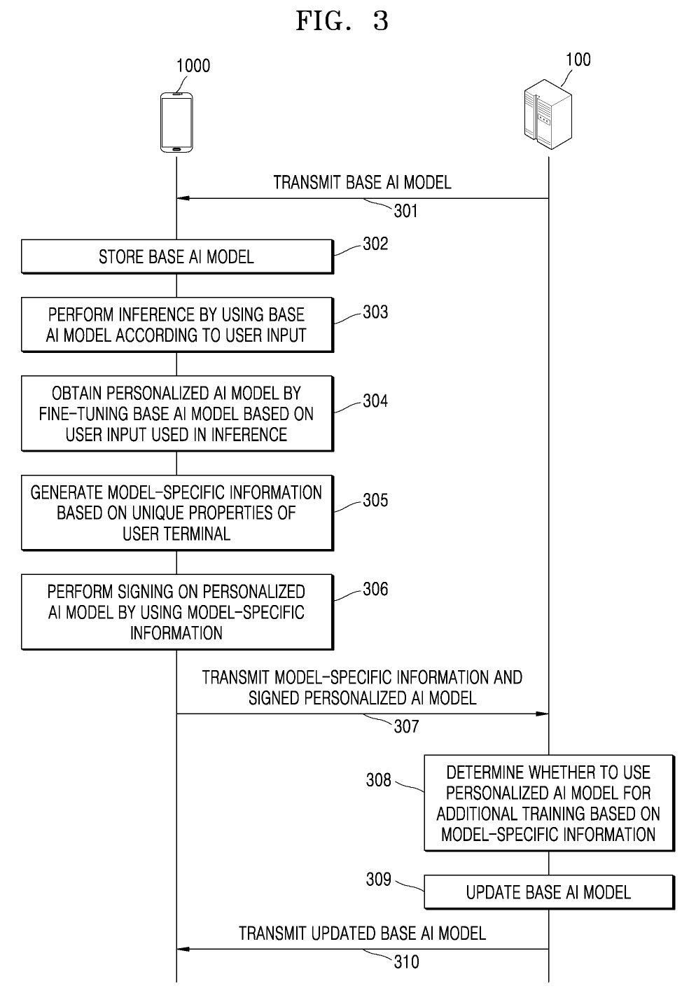

FIG. 3 shows operations performed by a user terminal and a server in sequence. Hereinafter, each operation is described in detail according to the order shown in FIG. 3.

### 2. Provide Base AI Model

In operation 301 of FIG. 3, the server 100 may transmit a base AI model to the user terminal 1000. According to an embodiment of the disclosure, the server 100 may request the user terminal 1000 to generate a secure instance before transmitting the base AI model.

When the user terminal 1000 requests the server 100 to download the base AI model, the server 100 may request the user terminal 1000 to generate a hardware-based independent secure instance within the TEE 1040. That is, the server 100 may request generation of a new isolated execution environment within the TEE 1040 such that an application or function that requires security may be executed. This is to provide an isolated execution environment for the base AI model to strengthen the security of the base AI model itself and the security of fine-tuning the base AI model.

When the user terminal 1000 generates the secure instance, the server 100 may transmit the base AI model to the user terminal 1000.

### 3. Execute the Base AI Model in the User Terminal

The user terminal 1000 may execute the base AI model received from the server 100 in an on-device environment.

In operation 302 of FIG. 3, the user terminal 1000 may store the received base AI model.

Then, in operation 303, the user terminal 1000 may perform an inference by using the base AI model according to user input. As described above, the user terminal 1000 may provide a UI for using the AI service to the user 1 through the REE 1030, and the user 1 may input a prompt (e.g., user input) through the UI.

The AI engine of the user terminal 1000 may execute the base AI model in at least one of the REE 1030 or the TEE 1040. For example, the AI engine may execute general calculation using the base AI model in the REE 1030, and execute some calculations that need security in the TEE 1040. Alternatively, for example, the AI engine may execute all calculations of the base AI model in either the REE 1030 or the TEE 1040.

### 4. Generate Personalized AI Model

In operation 304 of FIG. 3, the user terminal 1000 may obtain a personalized AI model by fine-tuning the base AI model based on the user input used in one or more inferences. The AI engine of the user terminal 1000 may maintain the security of the personalized AI model by performing fine-tuning in the TEE 1040. According to an embodiment of the disclosure, fine-tuning for generating the personalized AI model may be performed in an on-device environment, thereby optimizing the model while protecting the user’s privacy.

In one or more embodiments, the user terminal 1000 may receive the following user input (input data) through the REE 1030.
Text input by the user (e.g., prompt or user-related information);
Photo taken through a camera;
Voice information received through a microphone; and
Various information that the user directly inputs into the user terminal 1000 while using the AI service or that the user terminal 1000 collects during the process.

The user terminal 1000 may obtain user data by collecting user input as described above and perform fine-tuning on the base AI model by using the user data.

When the collected user data is used for fine-tuning, a problem such as private information leak may occur. Therefore, according to an embodiment of the disclosure, the user terminal 1000 may protect the privacy of the user 1 by not using the user data (input data) without change for fine tuning, but processing the user data into training data and then using the training data for fine-tuning. For example, the user terminal 1000 may anonymize and encrypt user data and then use the user data for additional training.

In the user terminal 1000, the personalized AI model may be generated in an undesired direction. Here, the ‘undesired direction’ may be interpreted in various ways, and for example, the undesired direction may be a direction that a service provider providing the base AI model does not want. Alternatively, for example, a direction in which learning is directed to generate answers that deviate from common sense may be the undesired direction. Alternatively, for example, a direction in which learning is directed to generate answers that are excessively biased to one side may be the undesired direction (e.g., answers that are excessively male-centric, or answers that are biased towards either conservative or progressive). When it is difficult for many users to use universally, it may be said that the personalized AI model is generated in the undesired direction.

The personalized AI model that is generated in the undesired direction is not suitable for use when updating the base AI model. In other words, the personalized AI model generated in the undesired direction may be an unsuitable model. For example, a maliciously trained personalized AI model or a personalized AI model trained with biased information may be an unsuitable model.

Attacks may be attempted to maliciously contaminate the model by using the properties (anonymization) of the training data described above. For example, in a process in which the user 1 uses an AI service, the performance of the model may be degraded or distorted in a certain direction by inputting malicious data. Alternatively, biased information that causes the model to learn incorrectly may be used during fine-tuning even when there is no malicious intent of the user 1.

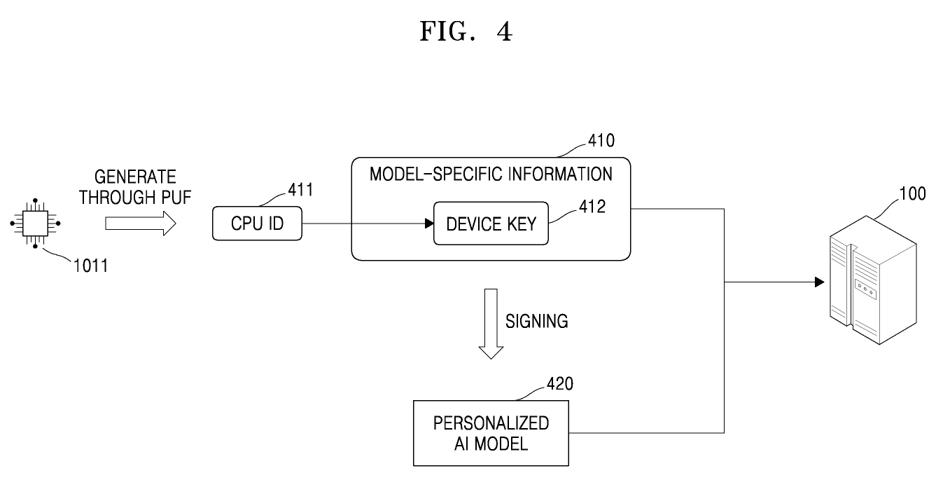

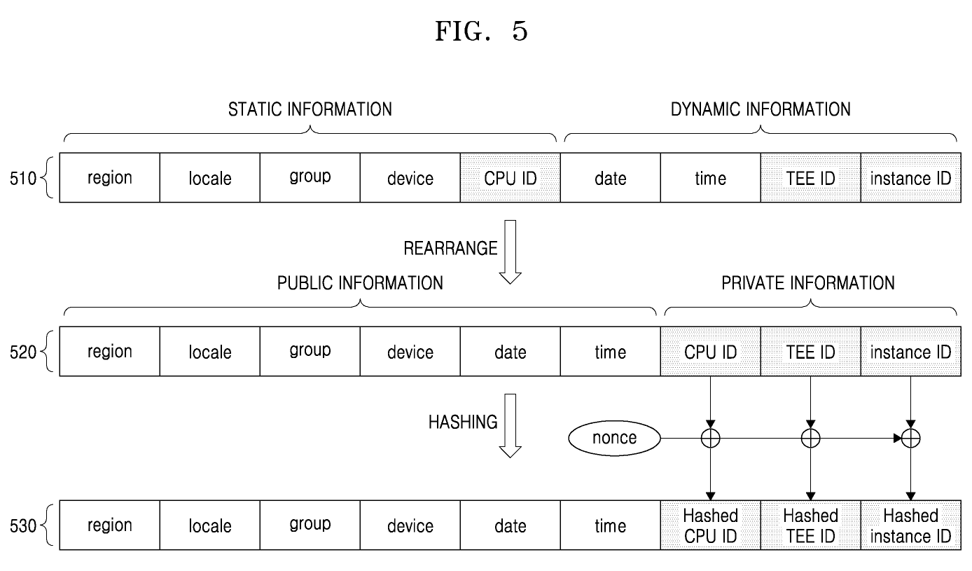

### 5. Transmit Model-specific Information and Personalized AI Models FIGS. 4 and 5

According to an embodiment of the disclosure, when transmitting a personalized AI model to the server 100, the user terminal 1000 may transmit model-specific information and the personalized AI model. The model-specific information may correspond to the personalized AI model. The user terminal 1000 may perform signing on the personalized AI model by using the model-specific information and then transmit the personalized AI model to the server. The model-specific information may be used to determine whether to incorporate the personalized AI model in an update of the base AI model in the server 100.

In operation 305 of FIG. 3, the user terminal 1000 may generate model-specific information based on the unique properties of the user terminal 1000. Hereinafter, with reference to FIGS. 4 and 5, a method by which the user terminal 1000 generates model-specific information corresponding to a personalized AI model will be described in detail.

FIG. 4 illustrates a process in which a user terminal generates model-specific information, performs signing on a personalized AI model by using the generated model-specific information, and then transmits the generated information to a server, according to an embodiment of the disclosure. Digital authentication related operations described below (e.g., device key generation or signing) may be performed in the TEE 1040.

The user terminal 1000 may generate a device key 412 corresponding to the user terminal 1000. The device key 412 may be generated based on the unique properties of the user terminal 1000, and thus may be used as identification information to distinguish the user terminal 1000 from other devices. Therefore, the device key 412 may be used to check the source of the personalized AI model.

According to an embodiment of the disclosure, the user terminal 1000 may generate the device key 412 based on the unique physical properties of the CPU chip 1011. Referring to FIG. 4, the user terminal 1000 may generate a physical unclonable function (PUF)-based key (CPU ID 411) corresponding to the unique physical properties of the CPU chip 1011 through a PUF. That is, the user terminal 1000 may generate the CPU ID 411 by using minute physical fluctuations that occur in the manufacturing process of the CPU chip 1011.

The user terminal 1000 may use the generated CPU ID 411 as the device key 412 or may generate the device key 412 by using the CPU ID 411. For example, the user terminal 1000 may generate the device key 412 by adding various pieces of information corresponding to the user terminal 1000 (e.g., model name, or serial number) to the CPU ID 411.

According to an embodiment of the disclosure, the user terminal 1000 may generate the device key 412 by using information other than the CPU ID 411. The user terminal 1000 may generate the device key 412 by using hardware-based unique information of the user terminal 1000, such as international mobile equipment (IMEI), a MAC address, or a serial number.

The user terminal 1000 may generate model-specific information 410 based on the device key 412. The model-specific information 410 according to an embodiment of the disclosure may be a nonce generated to specify an event of generation or transmission of the personalized AI model. Therefore, the model-specific information 410 may also be referred to as an event-specific nonce.

FIG. 5 illustrates detailed information included in model-specific information according to an embodiment of the disclosure. Referring to FIG. 5, the model-specific information may include the following detailed information.
① region: Information about a region in which the user terminal 1000 is located, which may indicate a region in which the personalized AI model was generated.
② locale: Information about regional settings (e.g., country and language settings) of the user terminal 1000.
③ group: Information about a group to which the user terminal 1000 belongs. The group may be determined based on the gender, age, and the like of the user 1.
④ device: Information about the user terminal 1000 (e.g., model name, or serial number).
⑤ date: Information about a date the personalized AI model was generated.
⑥ time: Information about a time the personalized AI model was generated.
⑦ CPU ID: PUF-based key corresponding to the CPU chip 1011 included in the user terminal 1000 (assuming that the CPU ID is used as the device key).
⑧ TEE ID: Information for identifying the TEE 1040 of the user terminal 1000 (Information for identifying the TEE 1040 in which the personalized AI model is generated).
⑨ Instance ID: Information for identifying the secure instance generated in the TEE 1040 of the user terminal 1000 (Information for identifying the secure instance in which the personalized AI model is generated).

As such, the model-specific information may include information about the location and time in which the personalized AI model is generated, information based on the hardware properties of the user terminal that generates the personalized AI model (CPU ID), and information based on a software environment in which the personalized AI model is generated (TEE ID or instance ID).

According to an embodiment of the disclosure, the user terminal 1000 may generate the model-specific information 410 by collecting detailed information, rearranging the information, and then performing hashing. The process in which the user terminal 1000 generates the model-specific information 410 is described in detail with reference to FIG. 5.

A first state 510 illustrated in FIG. 5 may represent a state in which the user terminal 1000 collects detailed information for the first time. The first state 510 is divided into a static information area and a dynamic information area, and the static information area may include, for example, a region, a locale, a group, a device, and a CPU ID, and the dynamic information area may include data, a time, a TEE ID, and an instance ID.

The user terminal 1000 may change from the first state 510 to a second state 520 by rearranging the detailed information. The second state 520 may be divided into a public information area and a private information area, and the public information area may include a region, a locale, a group, a device, a date, and a time, and the private information area may include a CPU ID, a TEE ID, and an instance ID. The private information area may include a unique key (CPU ID) corresponding to the user terminal 1000, and may also include information (TEE ID, or instance ID) about an environment in which the personalized AI model is generated in the user terminal 1000. That is, the detailed information included in the private information area (CPU ID, TEE ID, or instance ID) may be used as information to identify a source of the personalized AI model.

The user terminal 1000 may change from the second state 520 to a third state 530 by performing hashing on the detailed information (e.g., CPU ID, TEE ID, or instance ID) included in the private information area. The user terminal 1000 may perform hashing on the detailed information included in the private information area by using a randomly generated nonce.

According to an embodiment of the disclosure, the user terminal 1000 may perform hashing on each field of detailed information (CPU ID, TEE ID, or instance ID) included in the private information area, and thus, the model-specific information may be used as information for identifying the source of the personalized AI model.

In operation 306 of FIG. 3, the user terminal 1000 may perform signing on the personalized AI model by using the model-specific information. Referring to FIG. 4, the user terminal 1000 may obtain the device key 412 from the model-specific information 410 and perform signing by using the obtained device key 412.

Performing signing on a personalized AI model 420 may actually mean performing signing on ‘data of the personalized AI model’. In this case, the ‘data of personalized AI model’ may include information about a structure of nodes included in the personalized AI model and information about a parameter corresponding to each node.

Signing information may be transmitted to the server 100 and used to verify the integrity of the personalized AI model.

Then, in operation 307 of FIG. 3, the user terminal 1000 may transmit, to the server 100, the model-specific information and a signed personalized AI model. In this case, the user terminal 1000 may also transmit, to the server 100, a certificate including the device key 412.

### 6. Update the Base AI Model using a Personalized AI Model

The server 100 may receive personalized AI models from a plurality of terminals including the user terminal 1000 as needed or periodically, and update the base AI model by using the received personalized AI models. The server 100 may exclude some models that are not suitable for additional training from among the received personalized AI models and perform additional training on the base AI model by using the remaining models.

In operation 308 of FIG. 3, the server 100 may determine whether to use the personalized AI model for additional training based on the received model-specific information. However, to this end, at least one of the previously received personalized AI models may be determined to be an unsuitable model. Hereinafter, a method of determining whether a personalized AI model is an unsuitable model is described first, and then a method of determining whether to use the personalized AI model for additional training based on model-specific information is described.

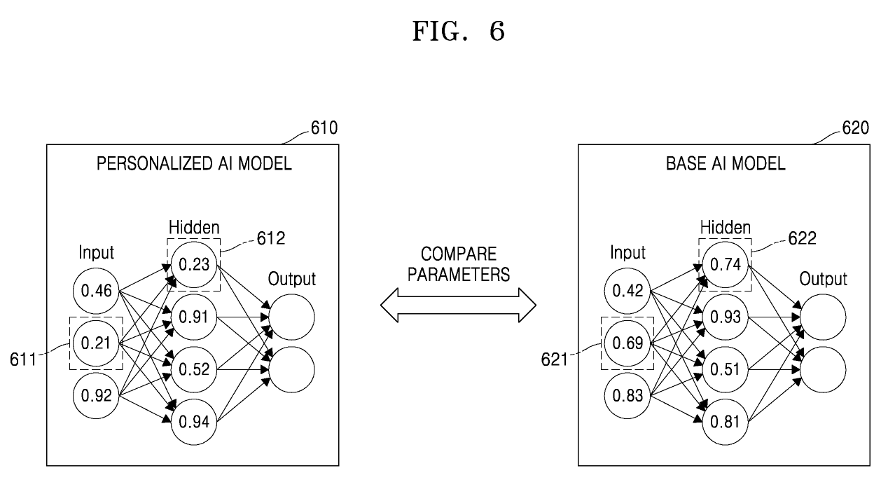

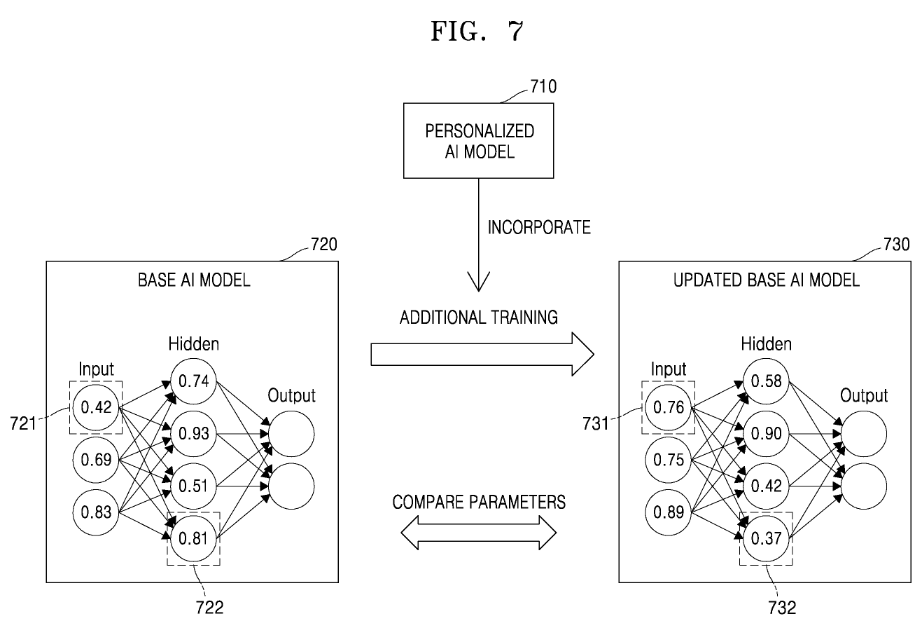

### 6-1. Method of Determining Whether a personalized AI Model is an Unsuitable Model FIGS. 6 and 7

According to an embodiment of the disclosure, the server 100 may detect an unsuitable model based on a degree of difference between the received personalized AI model and the base AI model stored in the server 100.

According to an embodiment of the disclosure, the server 100 may detect an unsuitable model based on a degree of difference between a model after the base AI model stored in the server 100 is updated (post-update model) by using the received personalized AI model and the base AI model (pre-update model).

That is, the server 100 may determine whether the personalized AI model is an unsuitable model by comparing parameters of models. As described above, the server 100 may determine whether the personalized AI model is an unsuitable model based on the result of comparing the parameters of any one of the following pairs of models.
i) Compare parameters between the personalized AI model and the base AI model; and
ii) Compare the parameters between a model after the base AI model is updated (post-update model) by using the personalized AI model and the base AI model (pre-update model).

FIG. 6 is a diagram illustrating a method of determining whether a personalized AI model is an unsuitable model by comparing parameters of the personalized AI model and the base AI model. The server 100 may determine whether a personalized AI model 610 is an unsuitable model by comparing parameters between a personalized AI model 610 and a base AI model 620.

For example, the server 100 may calculate a difference in parameter values for each pair of corresponding nodes of the two models 610 and 620, obtain an average of the differences calculated for all nodes, and compare the average with a predetermined threshold. When the average is greater than a predetermined threshold, the server 100 may determine that the personalized AI model 610 is an unsuitable model. In this case, a pair of corresponding nodes may mean a pair of nodes with the same location in each model.

In the embodiment illustrated in FIG. 6, differences in the parameter values calculated for each pair of corresponding nodes are 0.04, 0.48, 0.09, 0.51, 0.02, 0.01, and 0.13, and an average of the differences is 0.18. Therefore, the server 100 may determine that the personalized AI model 610 is an unsuitable model when 0.18 is greater than a predetermined threshold.

For example, the server 100 may calculate the difference in parameter values for each pair of corresponding nodes of the two models 610 and 620, obtain a variance of the differences calculated for all nodes, and compare the variance with a predetermined threshold. When the variance is greater than a predetermined threshold, the server 100 may determine that the personalized AI model 610 is an unsuitable model.

In the embodiment illustrated in FIG. 6, differences in the parameter values calculated for each pair of corresponding nodes are 0.04, 0.48, 0.09, 0.51, 0.02, 0.01, and 0.13, and a variance of the differences is 0.04. Therefore, the server 100 may determine that the personalized AI model 610 is an unsuitable model when 0.04 is greater than a predetermined threshold.

For example, the server 100 may calculate the difference in parameter values for each pair of corresponding nodes of the two models 610 and 620 and check the number of node pairs having a difference greater than a predetermined value, and when the checked number of node pairs is greater than a predetermined threshold, the server 100 may determine that the personalized AI model 610 is an unsuitable model.

It is assumed that a reference is set to determine the personalized AI model 610 as an unsuitable model when there are two or more node pairs having a parameter value difference exceeding 0.4. Referring to FIG. 6, when comparing a first node 611 of the personalized AI model 610 with a second node 621 of the base AI model 620, a difference in parameter values is 0.48. When comparing a second node 612 of the personalized AI model 610 with a second node 622 of the base AI model 620, a difference in parameter values is 0.51. There are two node pairs having a parameter value difference exceeding 0.4, and thus the server 100 may determine that the personalized AI model 610 is an unsuitable model.

FIG. 7 is a diagram for explaining a method of determining whether a personalized AI model is an unsuitable model by comparing parameters between a model after a base AI model is updated using the personalized AI model (post-update model) and a base AI model (pre-update model).

Referring to FIG. 7, the server 100 may obtain an updated base AI model 730 by performing additional training on a base AI model 720 by using a personalized AI model 710. Then, the server 100 may determine whether the personalized AI model 710 is an unsuitable model by comparing parameters between the base AI model 720 and the base AI model 730.

For example, the server 100 may calculate the difference in parameter values for each pair of corresponding nodes of the two models 720 and 730, obtain an average of the differences calculated for all nodes, and compare the average with a predetermined threshold. When the average is greater than a predetermined threshold, the server 100 may determine that the personalized AI model 710 is an unsuitable model. In this case, a pair of corresponding nodes may mean a pair of nodes with the same location in each model.

In the embodiment illustrated in FIG. 7, differences in the parameter values calculated for each pair of corresponding nodes are 0.34, 0.06, 0.06, 0.16, 0.03, 0.09, and 0.44, and an average of the differences is 0.17. Therefore, the server 100 may determine that the personalized AI model 710 is an unsuitable model when 0.17 is greater than a predetermined threshold.

For example, the server 100 may calculate the difference in parameter values for each pair of corresponding nodes of the two models 720 and 730, obtain a variance of the differences calculated for all nodes, and compare the variance with a predetermined threshold. When the variance is greater than a predetermined threshold, the server 100 may determine that the personalized AI model 710 is an unsuitable model.

In the embodiment illustrated in FIG. 7, differences in the parameter values calculated for each pair of corresponding nodes are 0.34, 0.06, 0.06, 0.16, 0.03, 0.09, and 0.44, and a variance of the differences is 0.02. Therefore, the server 100 may determine that the personalized AI model 710 is an unsuitable model when 0.02 is greater than a predetermined threshold.

For example, the server 100 may calculate the difference in parameter values for each pair of corresponding nodes of the two models 720 and 730 and check the number of node pairs having a difference greater than a predetermined value, and when the checked number of node pairs is greater than a predetermined threshold, the server 100 may determine that the personalized AI model 710 is an unsuitable model.

It is assumed that a reference is set to determine the personalized AI model 710 as an unsuitable model when there are two or more node pairs having a parameter value difference exceeding 0.4. Referring to FIG. 7, when comparing a first node 721 of the base AI model 720 with a first node 731 of the updated base AI model 730, a difference in parameter values is 0.34. When comparing a second node 722 of the base AI model 720 with a second node 732 of the updated base AI model 730, a difference in parameter values is 0.44. There is one node pair having a parameter value difference exceeding 0.4, and thus the server 100 may determine that the personalized AI model 710 is not an unsuitable model.

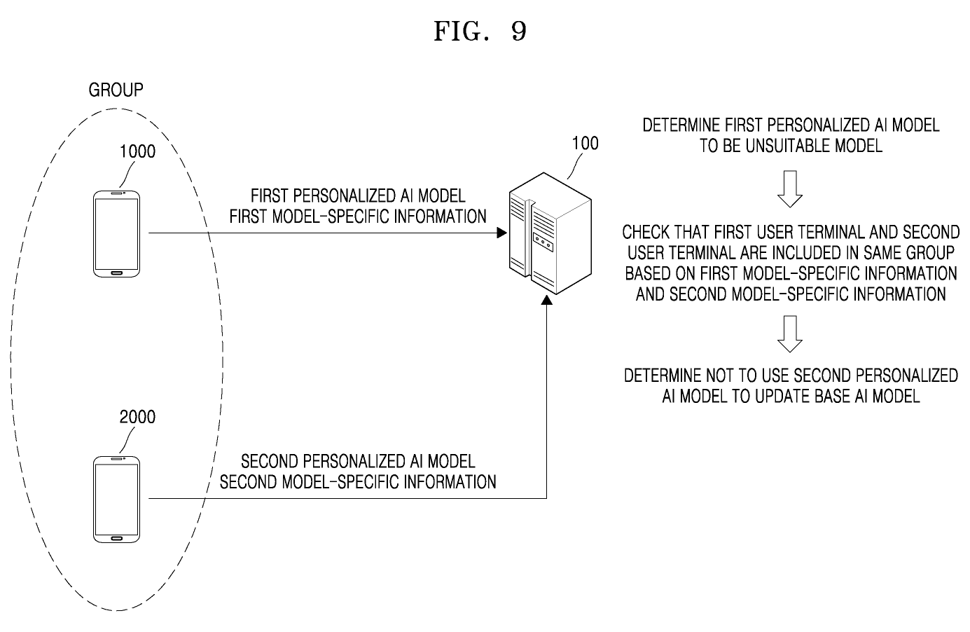

### 6-2. Method of Determining Whether to use a Personalized AI Model for Additional Training based on Model-specific Information FIGS. 8 and 9

When the server 100 discovers at least one personalized AI model that is determined as an unsuitable model according to the method described above, the server 100 may determine whether to use the personalized AI model received thereafter for updating the base AI model based on model-specific information received together.

According to an embodiment of the disclosure, the server 100 may determine, based on the model-specific information, whether the received personalized AI model is one of the following two types, and may determine not to use the following two types of models for updating the base AI model. Alternatively, the server 100 may not immediately determine not to use the following two types of models for updating the base AI model, but may determine whether the corresponding models are unsuitable models. The method of determining whether the corresponding models are unsuitable models is as described above.
i) Personalized AI model transmitted from a terminal that previously transmits an unsuitable model.
ii) Personalized AI model transmitted from a terminal having a high relevance with a terminal that previously transmits an unsuitable model.

FIGS. 8 and 9 are diagrams illustrating a process in which a server determines whether to use a personalized AI model to update a base AI model based on model-specific information.

Referring to FIG. 8, when the user terminal 1000 transmits, to the server 100, a first personalized AI model and first model-specific information, the server 100 may determine whether the first personalized AI model is an unsuitable model.

The server 100 may determine whether the first personalized AI model is an unsuitable model based on the result of comparing the parameters between the first personalized AI model and the base AI model stored in the server 100 by using the method described above with reference to FIGS. 6 and 7. The server 100 may determine whether the first personalized AI model is an unsuitable model based on the result of comparing parameters between a model after a base AI model is updated using the first personalized AI model (post-update model) and a base AI model (pre-update model).

In the situation illustrated in FIG. 8, it is assumed that the server 100 determines that the first personalized AI model is an unsuitable model.

After the first personalized AI model is determined to be an unsuitable model, when the user terminal 1000 transmits, to the server 100, a second personalized AI model and second model-specific information, the server 100 may determine whether to use the second personalized AI model to update the base AI model based on the second model-specific information. A detailed process is as follows.

The server 100 may compare the sources of the first personalized AI model and the second personalized AI model by comparing the first model-specific information and the second model-specific information. A private information area of the model-specific information may include detailed information such as a device key (e.g., CPU ID), a TEE ID, and an instance ID, and the server 100 may check and compare the sources of the respective models based on the detailed information. For example, when the device key included in the first model-specific information and the device key included in the second model-specific information are the same, the server 100 may determine that the sources of the first personalized AI model and the second personalized AI model are the same. The server 100 may also refer to the TEE ID and the instance ID when checking and comparing sources.

In the embodiment illustrated in FIG. 8, the server 100 may check that the first personalized AI model and the second personalized AI model are received from the same user terminal 1000, and therefore may determine not to use the second personalized AI model for updating the base AI model. The server 100 may determine whether the second personalized AI model is an unsuitable model and, when the second personalized AI model is an unsuitable model, the server 100 may determine not to use the second personalized AI model for updating the base AI model.

As such, the server 100 may check the source of the personalized AI model based on model-specific information and determine not to use a personalized AI model with the same source as an unsuitable model for updating the base AI model.

Referring to FIG. 9, when a first user terminal 1000 transmits, to the server 100, a first personalized AI model and first model-specific information, the server 100 may determine whether the first personalized AI model is an unsuitable model. The server 100 may determine whether the first personalized AI model is an unsuitable model by using the method described above.

In the situation illustrated in FIG. 9, it is assumed that the server 100 determines that the first personalized AI model is an unsuitable model.

After the first personalized AI model is determined to be an unsuitable model, when a second user terminal 2000 transmits, to the server 100, a second personalized AI model and second model-specific information, the server 100 may determine whether to use the second personalized AI model to update the base AI model based on the second model-specific information. A detailed process is as follows.

The server 100 may determine a relationship between the first user terminal 1000 that transmits the unsuitable model (the first personalized AI model) and the second user terminal 2000 that transmits the second personalized AI model by comparing the first model-specific information and the second model-specific information. That is, the server 100 may determine a relationship between the two terminals 1000 and 2000 and a degree of a relevance between the two terminals 1000 and 2000 based on model-specific information.

The model-specific information may include detailed information such as a region and time in which the personalized AI model is generated, and a group to which a terminal transmitting the personalized AI model belongs, and the server 100 may determine the relationship between the first user terminal 1000 and the second user terminal 2000 based on such detailed information.

When the relationship between the first user terminal 1000 and the second user terminal 2000 is one of the following, the server 100 may determine not to use the second personalized AI model for updating the base AI model. Alternatively, the server 100 may determine whether the second personalized AI model is an unsuitable model when the relationship between the first user terminal 1000 and the second user terminal 2000 is one of the following.
i) When the first user terminal 1000 and the second user terminal 2000 are owned by the same user.
ii) When the first user terminal 1000 and the second user terminal 2000 are included in the same group.

According to an embodiment of the disclosure, the server 100 may determine a degree of relevance between an unsuitable model (first personalized AI model) and the second personalized AI model based on model-specific information, and may determine whether to use the second personalized AI model to update the base AI model based on the result.

For example, the server 100 may calculate a score for a relevance between an unsuitable model (the first personalized AI model) and the second personalized AI model based on a location and time in which each model is generated and a group to which the terminal that generates the model belongs, and when the calculated score is equal to or greater than a preset reference, the server 100 may determine not to use the second personalized AI model for updating the base AI model.

As such, the server 100 may determine a relationship between the terminals that transmit the two models based on model-specific information, and determine not to use the personalized AI model transmitted from the terminal that has a high relevance with the terminal that previously transmits the unsuitable model for additional learning.

When the server 100 selects a personalized AI model to be used for additional training, the server 100 may update the base AI model by using the personalized AI model in operation 309 of FIG. 3.

Then, in operation 310 of FIG. 3, the server 100 may transmit the updated base AI model to the user terminal 1000.

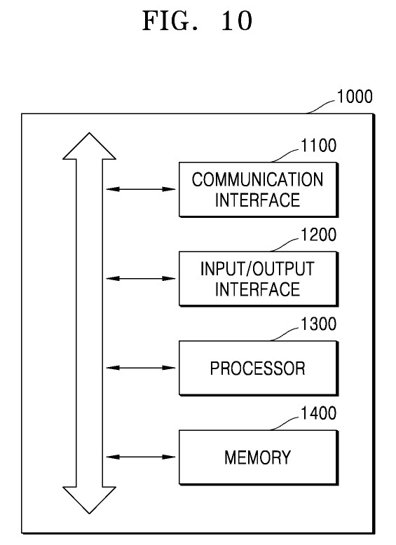

### 3. Overall Configuration and Operation of Electronic Device (user terminal) FIG. 10

Hereinafter, the configuration of the user terminal 1000 for performing the operations described thus far is described.

FIG. 10 is a diagram illustrating components included in a user terminal according to an embodiment of the disclosure. Referring to FIG. 10, the user terminal 1000 according to an embodiment of the disclosure may include a communication interface 1100, an input/output interface 1200, a processor 1300, and memory 1400.

The communication interface 1100 may be a component that transmits and receives a signal (control command and data) to and from an external device via wire or wirelessly, and may be implemented to include a communication chipset that supports various communication protocols. The communication interface 1100 may receive a signal from the outside and output the signal to the processor 1300, or transmit the signal output from the processor 1300 to the outside. The user terminal 1000 may receive a base AI model from the server 100 through the communication interface 1100 and transmit, to the server 100, model-specific information and a signed personalized AI model.

The input/output interface 1200 may include an input interface (e.g., touch screen, keyboard, and microphone) for receiving a command or information from a user, and an output interface (e.g., display panel, and speaker) for displaying the result of execution of an operation according to a user command or a state of the user terminal 1000. According to an embodiment of the disclosure, the user terminal 1000 may receive input (e.g., a prompt) from a user through the input/output interface 1200, and when an operation is completed, may output a result of performing the operation (e.g., an inference result) through the input/output interface 1200.

The processor 1300 may be a component that controls a series of processes such that the user terminal 1000 operates according to the embodiments described in the disclosure, and may include one or more processors. One or more processors included in the processor 1300 may be circuitry such as a system on chip (SoC), or an integrated circuit (IC). One or more processors included in the processor 1300 may be a general-purpose processor such as a central processing unit (CPU), a micro processor unit (MPU), an application processor (AP), and a digital signal processor (DSP), a graphics-only processor such as a graphics processing unit (GPU) and a vision processing unit (VPU), an artificial intelligence-only processor such as a neural processing unit (NPU), or a communication-only processor such as a communication processor (CP). When one or more processors included in the processor 1300 are artificial intelligence-dedicated processors, the corresponding artificial intelligence-dedicated processors may be designed with a hardware structure specialized for processing a specific artificial intelligence model.

According to an embodiment of the disclosure, the processor 1300 of FIG. 10 may correspond to the CPU chip 1011 of FIG. 2, or may include the CPU chip 1011 of FIG. 2.

The processor 1300 may write data to the memory 1400 or read data stored in the memory 1400, and in particular, process data according to predefined operation rules or artificial intelligence models by executing a program or at least one instruction stored in the memory 1400. Accordingly, the processor 1300 may perform the operations described in embodiments of the disclosure, and operations described as being performed by the user terminal 1000 or modules included in the user terminal 1000 in the disclosure may be considered as being performed by the processor 1300 unless otherwise specifically described.

The memory 1400 may be a component that stores various programs or data, and may include a storage medium or a combination of storage media such as read only memory (ROM), random-access memory (RAM), hard disk, compact disc-read only memory (CD-ROM), and digital versatile disc (DVD). The memory 1400 may not be present separately and may be included in the processor 1300. The memory 1400 may include volatile memory, non-volatile memory, or a combination of volatile memory and non-volatile memory. The memory 1400 may store a program or at least one instruction for performing operations according to embodiments described hereinbelow. The memory 1400 may also provide stored data to the processor 1300 according to a request of the processor 1300.

The embodiments described above with reference to FIGS. 1-9 may be performed by the user terminal 1000.

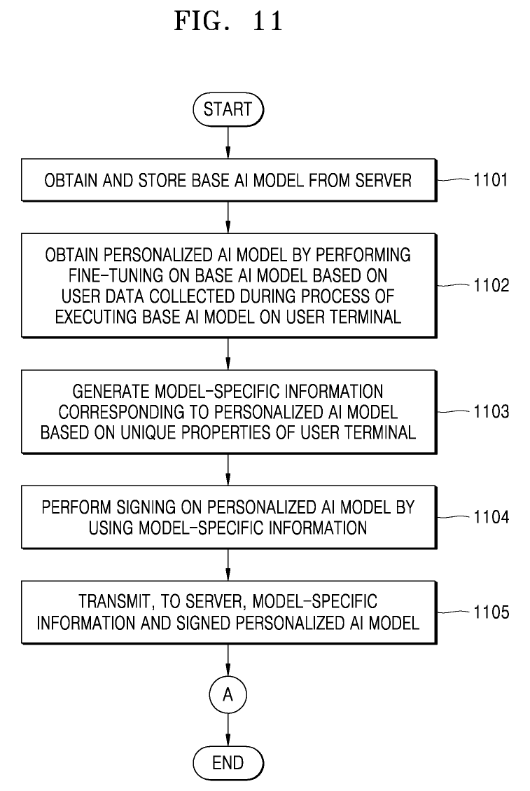

### 4. Describe the Process with Reference to the Flowcharts FIGS. 11-14

Hereinafter, with reference to the flowcharts of FIGS. 11-14, a method of updating an AI model in a cloud environment according to embodiments of the disclosure will be described. The operations included in the flowcharts of FIGS. 11-14 may be performed by the user terminal 1000 of FIG. 10, and thus the contents described above with reference to FIGS. 1-10 may be equally applied to FIGS. 11-14 even when omitted below.

Referring to FIG. 11, in operation 1101, the user terminal may obtain and store the base AI model from the server.

In operation 1102, the user terminal may obtain the personalized AI model by performing fine-tuning on the base AI model based on user data collected during a process of executing the base AI model in an on-device environment. In this case, the user terminal may anonymize or encrypt user data to protect the user’s privacy, process the user data into training data, and then use the user data for fine-tuning.

In operation 1103, the user terminal may generate model-specific information corresponding to the personalized AI model based on the unique properties of the user terminal. The model-specific information generated as such may include information about the region and time in which the personalized AI model is generated, information based on the hardware properties of the user terminal, and information based on a software environment in which the personalized AI model is generated. In this case, information based on the software environment in which the personalized AI model is generated may include information for identifying a security environment in which the personalized AI model is executed in the user terminal. The model-specific information may be used to determine whether to incorporate the personalized AI model in an update of the base AI model in the server.

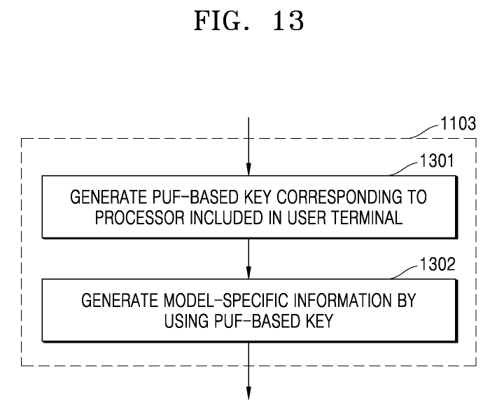

Detailed operations included in operation 1103 are illustrated in FIG. 13.

Referring to FIG. 13, in operation 1301, the user terminal may generate a PUF-based key corresponding to a processor included in the user terminal. That is, the user terminal may generate a PUF-based key corresponding to the unique physical properties of the processor.

Then, in operation 1302, the user terminal may generate model-specific information by using the PUF-based key.

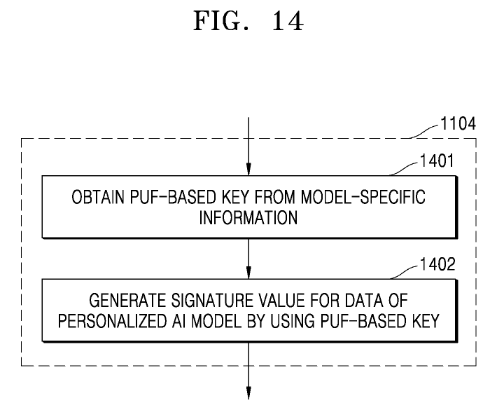

Referring back to FIG. 11, in operation 1104, the user terminal may perform signing on the personalized AI model by using the model-specific information. Detailed operations included in operation 1104 are illustrated in FIG. 14.

Referring to FIG. 14, in operation 1401, the user terminal may obtain a PUF-based key from model-specific information.

Then, in operation 1402, the user terminal may generate a signature value for data of the personalized AI model by using the PUF-based key. In this case, the ‘data of personalized AI model’ may include information about a structure of nodes included in the personalized AI model and information about a parameter corresponding to each node.

Referring back to FIG. 11, in operation 1105, the user terminal may transmit, to the server, the model-specific information and the signed personalized AI model.

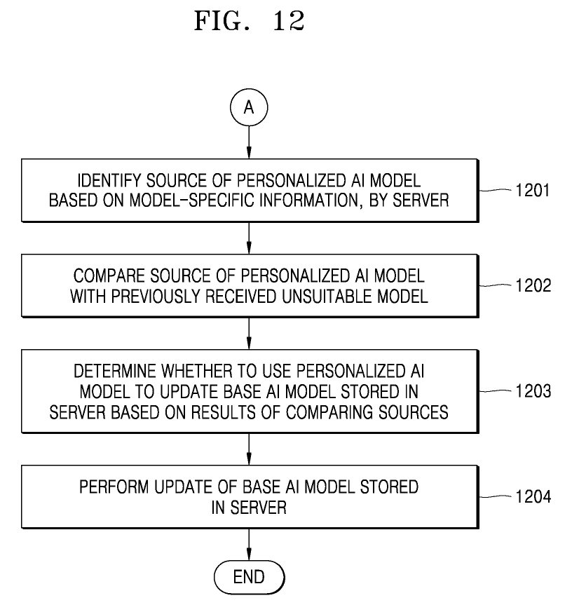

FIG. 12 illustrates operations performed by the server after receiving model-specific information and a personalized AI model.

Referring to FIG. 12, in operation 1201, the server may identify the source of the personalized AI model based on the model-specific information. That is, the server may identify a terminal that generates or transmits the personalized AI model based on the model-specific information. According to an embodiment of the disclosure, the model-specific information may include detailed information such as a device key (e.g., CPU ID), a TEE ID, and an instance ID corresponding to the user terminal that transmits the personalized AI model, and the server may identify the source of the personalized AI model based on the detailed information.

In operation 1202, the server may compare the source of the personalized AI model with the previously received unsuitable model.

In operation 1203, the server may determine whether to use the personalized AI model to update the base AI model stored in the server based on the results of comparing the sources. According to an embodiment of the disclosure, the server may determine not to use the personalized AI model to update the base AI model when the source of the previously received unsuitable model is the same as the source of the personalized AI model. Alternatively, according to an embodiment of the disclosure, the server may determine not to use the personalized AI model for updating the base AI model when the owners of a first terminal and a second terminal are the same, or the first terminal and the second terminal are included in the same group, even when a terminal (the first terminal) that transmits the previously received unsuitable model and a terminal (the second terminal) that transmits the personalized AI model are not the same.

Referring back to FIG. 12, in operation 1204, the server may perform an update of the base AI model stored in the server. When the update of the base AI model is complete, the server may transmit the base AI model to the user terminal.

A method according to an embodiment of the disclosure may include obtaining and storing a base AI model from a server by a user terminal, obtaining a personalized AI model by performing fine-tuning on the base AI model based on user data collected in a process of executing the base AI model by the user terminal, generating model-specific information corresponding to the personalized AI model based on unique properties of the user terminal, performing signing on the personalized AI model by using the model-specific information, and transmitting the model-specific information and the signed personalized AI model to the server.

According to an embodiment of the disclosure, the generating of the model-specific information may include generating a physical unclonable function (PUF)-based key corresponding to a processor included in the user terminal, and generating the model-specific information based on the PUF-based key.

According to an embodiment of the disclosure, the performing of the signing may include obtaining the PUF-based key from the model-specific information and generating a signature value for data of the personalized AI model by using the PUF-based key, and in this case, the data of the personalized AI model may include information on a structure of nodes included in the personalized AI model and information on a parameter corresponding to each node.

According to an embodiment of the disclosure, the model-specific information may include information about the region and time in which the personalized AI model is generated, information based on hardware properties of the user terminal, and information based on the software environment in which the personalized AI model is generated.

According to an embodiment of the disclosure, information based on the software environment in which the personalized AI model is generated may include information for identifying a security environment in which the personalized AI model is executed in the user terminal.

According to an embodiment of the disclosure, the model-specific information may be used by the server to determine whether to incorporate the personalized AI model in an update of the base AI model.

According to an embodiment of the disclosure, the method may further include identifying a source of the personalized AI model based on the model-specific information by the server, comparing the source of the personalized AI model with a previously received unsuitable model by the server, determining whether to use the personalized AI model to update a base AI model stored in the server based on a result of comparing the sources by the server, and performing an update of the base AI model stored in the server by the server.

According to an embodiment of the disclosure, the determining of whether to use the personalized AI model to update the base AI model stored in the server may include determining not to use the personalized AI model to update the base AI model when the source of the previously received unsuitable model is the user terminal.

According to an embodiment of the disclosure, the determining of whether to use the personalized AI model to update the base AI model stored in the server may include determining not to use the personalized AI model to update the base AI model when the source of the previously received unsuitable model is a second user terminal, and the user terminal and the second user terminal have the same owner, or the user terminal and the second user terminal are included in the same group.

According to an embodiment of the disclosure, the user data may include at least one of a user input received during a process of executing the base AI model on the user terminal, a record of an interaction between the user and the user terminal, or information related to the user.

According to an embodiment of the disclosure, the user terminal may include memory storing a program or at least one instruction, and at least one processor operatively coupled to the memory, and in this case, the at least one processor may execute the program stored in the memory or the at least one instruction to cause the user terminal to obtain and store a base AI model from a server, obtain a personalized AI model by performing fine-tuning on the base AI model based on user data collected in a process of executing the base AI model, generate model-specific information corresponding to the personalized AI model based on unique properties of the user terminal, perform signing on the personalized AI model by using the model-specific information, and then transmit the model-specific information and the signed personalized AI model to the server.

According to an embodiment of the disclosure, when generating the model-specific information, the user terminal may generate a physical unclonable function (PUF)-based key corresponding to the processor, and then generate the model-specific information based on the PUF-based key.

According to an embodiment of the disclosure, when the user terminal performs the signing, the user terminal may obtain the PUF-based key from the model-specific information and generate a signature value for data of the personalized AI model by using the PUF-based key, and in this case, the data of the personalized AI model may include information on a structure of nodes included in the personalized AI model and information on a parameter corresponding to each node.

According to an embodiment of the disclosure, the model-specific information may include information about the region and time in which the personalized AI model is generated, information based on hardware properties of the user terminal, and information based on the software environment in which the personalized AI model is generated.

According to an embodiment of the disclosure, information based on the software environment in which the personalized AI model is generated may include information for identifying a security environment in which the personalized AI model is executed in the user terminal.

According to an embodiment of the disclosure, the model-specific information may be used by the server to determine whether to incorporate the personalized AI model in an update of the base AI model.

According to an embodiment of the disclosure, a system for updating an AI model in a cloud environment may include a server configured to provide a base AI model, update the base AI model, and a user terminal configured to provide a UI for using the base AI model, and in this case, the user terminal may obtain and store the base AI model from the server, obtain a personalized AI model by performing fine-tuning on the base AI model based on user data collected in a process of executing the base AI model, generate model-specific information corresponding to the personalized AI model based on unique properties of the user terminal, perform signing on the personalized AI model by using the model-specific information, and then transmit the model-specific information and the signed personalized AI model to the server.

According to an embodiment of the disclosure, the server may identify a source of the personalized AI model based on the model-specific information, compare the source of the personalized AI model with a previously received unsuitable model, determine whether to use the personalized AI model to update a base AI model stored in the server based on a result of comparing the sources, and performing an update of the base AI model stored in the server.

According to an embodiment of the disclosure, when the server determines whether to use the personalized AI model to update the base AI model stored in the server, the server may determine not to use the personalized AI model to update the base AI model when the source of the previously received unsuitable model is the user terminal.

Various embodiments of the disclosure may be implemented or supported by one or more computer programs, and computer programs may be formed from computer-readable program code and may be recorded in a computer-readable medium. In the disclosure, the “application” and “program” are one or more computer programs, software components, command sets, procedures, functions, objects, classes, instances, related data, or parts thereof, which are suitable for implementation in computer readable program code. The “computer-readable program code” may include various types of computer codes including source code, purpose code, and executable code. The “computer-readable medium” may include various types of media to be accessed by a computer, such as read only memory (ROM), random access memory (RAM), hard disk drive (HDD), compact disc (CD), digital video disc (DVD), or various types of memories.

A device-readable storage medium may be provided in the form of a non-transitory storage medium. Here, the “non-transitory storage medium” is a tangible device and may exclude wired, wireless, optical, or other communication links that transmit temporary electrical or other signals. The “non-transitory storage medium” may not distinguish between semi-permanent and temporary storage of data in the storage medium. For example, “non-transitory storage medium” may include a buffer in which data is temporarily stored. A computer-readable medium may be any available medium to be accessed by a computer, and may include volatile and non-volatile media, and separate and non-separated media. The computer-readable medium includes a medium in which data is permanently stored and a medium in which data is stored and overwritten later, such as a rewritable optical disk or an erasable memory device.

According to an embodiment of the disclosure, the method according to the various embodiments disclosed herein may be included in a computer program product and provided. The computer program product may be traded between a seller and a buyer as a product. The computer program product may be distributed in the form of a storage medium (e.g. compact disk read only memory (CD-ROM)) that is to be read on a device, or may be distributed (e.g., downloaded or uploaded) directly or online through an application store or between two user devices (e.g., smartphones). In the case of online distribution, at least some of the computer program products (e.g., downloadable application) may be at least temporarily stored in a device-readable storage medium such as a server of a manufacturer, a server of an application server, or memory of a relay server, or may be temporarily generated.

The above description of the disclosure is for an example, and one of ordinary skill in the art understands that various changes in form and details may be easily made without changing the technical ideas or required characteristics of the disclosure. For example, the technologies may be performed in a different order from the described methods, and/or the system, structure, device, and circuit described above may be coupled or combined in a different form from the methods described above, or may be replaced or substituted by elements or equivalent objects, thereby achieving appropriate results. Therefore, the above-described embodiments of the disclosure need to be understood as exemplary and not limited in any way. For example, each component described in a single type may be distributed and performed, and similarly, components that are described as distributed may also be performed in a combined form.

The scope of the disclosure is defined by the claims described below rather than the detailed description, and needs to be interpreted as contained in the range of the disclosure or modified form derived from the meaning and range of the claims and an equivalent concept thereof.

1. A method comprising:
obtaining, by a user terminal, a base artificial intelligence (AI) model, wherein the base AI model is obtained from a server;
obtaining, by the user terminal, a personalized AI model by performing fine-tuning on the base AI model based on user data, wherein the user data is collected in a process of executing the base AI model on the user terminal;
generating, by the user terminal, model-specific information corresponding to the personalized AI model based on unique properties of the user terminal;
performing, by the user terminal, signing on the personalized AI model by using the model-specific information; and
transmitting, by the user terminal to the server, the model-specific information and the signed personalized AI model.

2. The method of claim 1, wherein the generating of the model-specific information comprises:
generating, by the user terminal, a physical unclonable function (PUF)-based key corresponding to at least one processor included in the user terminal; and
generating, by the user terminal, the model-specific information based on the PUF-based key.

3. The method of claim 2, wherein the performing of the signing comprises:
obtaining, by the user terminal, the PUF-based key from the model-specific information; and
generating, by the user terminal, a signature value for data of the personalized AI model by using the PUF-based key,
wherein the data of the personalized AI model comprises information about a structure of nodes included in the personalized AI model and information about a parameter corresponding to each node.

4. The method of claim 1, wherein the model-specific information comprises information on a region and time at which the personalized AI model was generated, information based on hardware properties of the user terminal, and information based on a software environment in which the personalized AI model was generated.

5. The method of claim 4, wherein the information based on the software environment in which the personalized AI model was generated comprises information for identifying a security environment in which the personalized AI model is executed in the user terminal.

6. The method of claim 1, wherein the model-specific information is used by the server to determine whether to incorporate the personalized AI model in an update of the base AI model.

7. The method of claim 1, further comprising:
identifying, by the server, a source of the personalized AI model based on the model-specific information;
comparing, by the server, the source of the personalized AI model with a source of a previously received unsuitable model;
determining, by the server, whether to use the personalized AI model to update the base AI model stored in the server based on a result of comparing the source of the personalized AI model and the source of the previously received unsuitable model; and
based on determining to use the personalized AI model to update the base AI model, performing, by the server, an update of the base AI model stored in the server.

8. The method of claim 7, wherein the determining of whether to use the personalized AI model to update the base AI model stored in the server comprises:
in response to the source of the previously received unsuitable model is the user terminal, determining not to use the personalized AI model for updating the base AI model.

9. The method of claim 7, wherein the determining of whether to use the personalized AI model to update the base AI model stored in the server comprises:
determining not to use the personalized AI model for updating the base AI model based on the user terminal and a second user terminal being in a same group, or an owner of the user terminal also owning the second user terminal, wherein the source of the previously received unsuitable model is the second user terminal.

10. The method of claim 1, wherein the user data comprises at least one of an input of a user received during a process of executing the base AI model in the user terminal, a record of an interaction between the user and the user terminal, or information related to the user.

11. A non-transitory computer-readable recording medium storing instructions that when executed by at least one processor, perform the method of claim 1.

12. A user terminal comprising:
memory storing instructions; and
at least one processor operatively coupled to the memory and comprising processing circuitry,
wherein the at least one processor individually or collectively executes the instructions to cause the user terminal to:
obtain a base AI model from a server,
obtain a personalized AI model by performing fine-tuning on the base AI model based on user data, wherein the user data is collected in a process of executing the base AI model,
generate model-specific information corresponding to the personalized AI model based on unique properties of the user terminal,
perform signing on the personalized AI model by using the model-specific information, and
transmit, to the server, the model-specific information and the signed personalized AI model.

13. The user terminal of claim 12, wherein generating the model-specific information comprises to:
generate a physical unclonable function (PUF)-based key corresponding to the at least one processor, and
generate the model-specific information based on the PUF-based key.

14. The user terminal of claim 13, wherein performing the signing comprises to:
obtain the PUF-based key from the model-specific information, and
generate a signature value for data of the personalized AI model by using the PUF-based key, and
wherein the data of the personalized AI model comprises information about a structure of nodes included in the personalized AI model and information about a parameter corresponding to each node.

15. The user terminal of claim 12, wherein the model-specific information comprises information on a region and time at which the personalized AI model was generated, information based on hardware properties of the user terminal, and information based on a software environment in which the personalized AI model was generated.

16. The user terminal of claim 15, wherein the information based on the software environment in which the personalized AI model was generated comprises information for identifying a security environment in which the personalized AI model is executed in the user terminal.

17. The user terminal of claim 12, wherein the model-specific information is used by the server to determine whether to incorporate the personalized AI model in an update of the base AI model.

18. A system for updating an artificial intelligence (AI) model in a cloud environment, the system comprising:
a server configured to provide a base AI model and update the base AI model; and
a user terminal configured to provide a user interface (UI) for using the base AI model,
wherein the user terminal is configured to:
obtain the base AI model from the server,
obtain a personalized AI model by performing fine-tuning on the base AI model based on user data, wherein the user data is collected in a process of executing the base AI model,
generate model-specific information corresponding to the personalized AI model based on unique properties of the user terminal,
perform signing on the personalized AI model by using the model-specific information, and
transmit, to the server, the model-specific information and the signed personalized AI model.

19. The system of claim 18, wherein the server is configured to:
identify a source of the personalized AI model based on the model-specific information,
compare the source of the personalized AI model with a source of a previously received unsuitable model,
determine whether to use the personalized AI model to update the base AI model stored in the server based on a result of comparing the source of the personalized AI model and the source of the previously received unsuitable model, and
based on determining to use the personalized AI model to update the base AI model, perform an update of the base AI model stored in the server.

20. The system of claim 19, wherein determining whether to use the personalized AI model to update the base AI model stored in the server comprises
in response to the source of the previously received unsuitable model is the user terminal, determining not to use the personalized AI model for updating the base AI model.
